(19) United States
(12) Patent Application Publication
(10) Pub. No.: US 2020/0346950 A1
(43) Pub. Date: Nov. 5, 2020

(54) RENEWABLE-POWERED REVERSE OSMOSIS DESALINATION WITH ACTIVE FEEDWATER SALINITY CONTROL FOR MAXIMUM WATER PRODUCTION EFFICIENCY WITH VARIABLE ENERGY INPUT

(71) Applicant: THE TRUSTEES OF COLUMBIA UNIVERSITY IN THE CITY OF NEW YORK, New York, NY (US)

(72) Inventors: Adam A. ATIA, Brooklyn, NY (US); Vasilis M. FTHENAKIS, Dix Hills, NY (US)

(73) Assignee: THE TRUSTEES OF COLUMBIA UNIVERSITY IN THE CITY OF NEW YORK, New York, NY (US)

(21) Appl. No.: 16/841,998

(22) Filed: Apr. 7, 2020

Related U.S. Application Data
(63) Continuation-in-part of application No. 16/479,406, filed on Jul. 19, 2019.
(60) Provisional application No. 62/578,060, filed on Oct. 27, 2017.
(60) Provisional application No. 62/490,192, filed on Apr. 26, 2017.
(60) Provisional application No. 62/448,578, filed on Jan. 20, 2017.
(60) Provisional application No. 62/831,019, filed on Apr. 8, 2019.

(51) Int. Cl. C02F 1/44; C02F 1/00; B01D 61/02; B01D 61/08; B01D 61/12

(52) U.S. Cl. CPC C02F 1/441; C02F 1/008; C02F 2103/08; B01D 61/08; B01D 61/12; B01D 61/025

(57) ABSTRACT

Methods and systems for desalinating feedwater are disclosed. The system includes at least one feedwater source, a reverse osmosis module, an input feedwater stream fed to the reverse osmosis module, and a control module. The feedwater stream comprises water from at least one feedwater source, e.g., from two or more feedwater sources of different salinities. The control module analyzes the level of energy available to the system, and increases the salinity of the input feedwater stream proportional to an increase in available energy. Feedwater stream salinity can be adjusted to reach water demand targets and fully utilize variable power inputs from renewable sources.

### CROSS REFERENCE TO RELATED APPLICATION(S)

This application is a continuation-in-part of U.S. Utility patent application Ser. No. 16/479,406, filed Jul. 19, 2019, which is a national stage patent filing of International Patent Application No. PCT/US2018/014615, filed Jan. 22, 2018, which claims the benefit of U.S. Application Nos. 62/448,578, filed Jan. 20, 2017, 62/490,192, filed Apr. 26, 2017, and 62/578,060, filed Oct. 27, 2017, which are incorporated by reference as if disclosed herein in their entirety. This application also claims the benefit of U.S. Application No. 62/831,019, filed Apr. 22, 2019, which is incorporated by reference as if disclosed herein in its entirety.

### STATEMENT REGARDING FEDERALLY SPONSORED RESEARCH OR DEVELOPMENT

This invention was made with government support under DGE-11-44155 awarded by National Science Foundation. The government has certain rights in the invention.

### BACKGROUND

Water scarcity is on the rise globally as climate change and increasing populations tax existing freshwater supplies. Water desalination plants often use reverse osmosis (RO), powered by an external energy source, as a way to remove the salt from brackish water or seawater. RO is the most energy-efficient and cost-effective desalination technology commercially available today, and is already being used for freshwater production in water-scarce regions. RO works by forcing the comparatively salty feedwater through a filter at a pressure greater than its osmotic pressure, which is linearly related to the water's salt concentration. Therefore, the amount of energy used or required by the water plant can be changed simply as a function of changing water salinity.

While RO is plain enough in theory, there are a number of complications that plague the efficiency of RO water desalination plants. RO water desalination plants are often plagued by high energy-intensiveness, high levels of polluting (such as through green-house gas emissions and brine discharge), high cost, and the requirement to be run at steady-state. To operate at steady-state, the plant must always be drawing energy at maximum capacity. This in turn makes the water plants cost inefficient and inflexible with regard to changing circumstances, including available energy supply.

As energy policy pushes towards the use of more renewables on the electric grid, the problems of over-generation and high ramp rates present significant challenges to grid operators, mainly in terms of resulting revenue losses and grid instability. Unless enough water can be produced at that always-elevated level of power input, any excess energy is wasted, and such a situation can damage the osmotic filters. Other operational parameters, such as electricity price, electricity availability, water demand, and feedwater temperature play a role in system efficiency. Plants using renewable power could draw different amounts of clean power at different times, though its unreliability risks water production outages. While renewable power variations can be treated by implementing energy storage, depending solely on such a solution is costly.

There is a need for the design of a novel integrated energy and desalination system that can provide potable water and vary its energy consumption in a versatile manner to provide electricity system services, while also improving economic and environmental viability.

### SUMMARY

An integrated energy and desalination design is proposed here, where access to seawater, treated wastewater effluent, and renewable energy resources can simultaneously mitigate water scarcity and facilitate services to the electricity system through time-shifting of energy usage, demand-response, and ancillary services. Furthermore, site-specific factors such as energy market structure, existing infrastructure, and geographical features can be exploited to reduce cost.

In some embodiments, the present disclosure is directed to a system for more efficiently desalinating feedwater utilizing RO and methods of that system's use. In some embodiments, the RO water desalination system runs using renewable energy and with active control over feedwater salinity. In some embodiments, the feedwater salinity can be explicitly and actively controlled in quasi-real-time. In some embodiments, feedstreams undergoing RO in the system are comprised of feedwater from two or more feedwater sources of different salinities. Feedwater stream salinity can be adjusted to reach water demand targets and fully utilize variable power inputs from renewable sources.

Feedwater salinity is directly proportional to the osmotic pressure (i.e. higher salinity corresponds to higher osmotic pressure), and high-pressure pumps have to pressurize the feedwater to levels that exceed the osmotic pressure in order for freshwater to permeate through RO membranes. Therefore, osmotic pressure is directly related to the energy consumption required for the process; in essence, actively controlling feedwater salinity translates to active control of the osmotic pressure and in turn the energy consumption. The ability to adjust feedwater stream salinity likewise bestows the ability to adjust water plant energy consumption. Together, these allow superior efficient use of energy, as when excess power is being produced, feedwater salinity can be raised to match the power supply. The systems and methods of the present disclosure optimize energy usage for water desalination and enable a flexible energy consumption profile for a desalination plant based on variable parameters such as feedwater temperature, electricity availability and price, water demand, and the like, to maximize cost efficiency.

In some embodiments, the present disclosure is directed to systems and methods for blending feedwater streams from two or more feedwater sources at a variable rate to control feedwater salinity in quasi-real-time as needed to maximize potable water production at minimum cost and match the variable power profile to balance supply (e.g. photovoltaic power generation) and demand (e.g., electric load profile of the desalination system). As feedwater salinity dictates plant energy demand, adjusting it allows variable energy consumption to meet energy availability and water demand. Optimal system operating parameters also account for other variables such as electricity price, feedwater temperature, water demand, and other relevant parameters that play an important role in optimizing RO desalination operations. Variable-power pumping, variable feedwater salinity control, and flexible membrane flow configurations also enhance demand-response capabilities, compensating for stressors on the grid while continuously producing potable water.

In some embodiments, the system is powered by renewable photovoltaics (PV). The synergy of high solar radiation and significantly reduced costs in PV creates the opportunity for PV to be a dominant and sustainable solution for powering the energy-intensive process of desalination. In some embodiments, the system incorporates energy storage, thus increasing flexibility.

Another advantage of the systems and methods of the present disclosure is that the use of multiple feedwater sources (especially one of them being treated wastewater effluent) ensures higher reliability and system utilization. Overall, this system can enable potable water production through desalination and water reuse at a lower cost of water and facilitate flexible energy consumption (and reduce total energy consumption) while utilizing clean renewable energy to eliminate greenhouse gas emissions. Furthermore, this concept enables treatment of both low- and high-salinity feedwater which would ensure a higher system utilization rate, reduce costs and energy consumption, facilitate brine dilution, reuse wastewater, and could provide retrofitting potential for existing RO plants that lack flexibility.

While photovoltaic-powered reverse osmosis is a promising technological solution, a number of significant challenges must be further addressed to sustain high RO performance. First, the inherently intermittent nature of solar energy generation can adversely affect the freshwater conversion process and thereby decrease water recovery. Second, RO performance is strongly dependent on feedwater quality control to minimize operating issues such as membrane-scaling and biofouling, and to maintain stability throughout fluctuations in feedwater composition, for instance, due to runoff and/or point source pollution. Third, the freshwater end-use (e.g., drinking, agricultural, industrial) determines the required water quality and the intensity of treatment needed.

### BRIEF DESCRIPTION OF THE DRAWINGS

The drawings show embodiments of the disclosed subject matter for the purpose of illustrating the invention. However, it should be understood that the present application is not limited to the precise arrangements and instrumentalities shown in the drawings, wherein:

FIG. 1 is a schematic representation of a system for desalinating feedwater according to some embodiments of the present disclosure;

FIG. 2 is a schematic representation of a system for desalinating feedwater according to some embodiments of the present disclosure;

FIG. 3 is a representative gird supply-demand profile from 2016 for the state of California; and

FIG. 4 is an estimated levelized cost of water breakdown of the systems according to some embodiments of the present disclosure.

### DESCRIPTION

In some embodiments, the present disclosure is directed to a RO desalination system for maximizing potable water production at minimal levelized water cost by actively controlling feedwater salinity and adapting to variable renewable power inputs. In some embodiments, the system includes at least one variable-speed pump. In some embodiments, each feed water supply is in fluid communication with at least one variable-speed pump. In some embodiments, a plurality of feedwater sources are in fluid communication with the system of the present disclosure, as will be discussed in greater detail below. In some embodiments, a RO module is in fluid communication with a plurality of feedwater streams. In some embodiments, each feedwater stream in fluid communication with the RO module represents a separate feedwater source. In some embodiments, at least two of the feedwater sources have different salinity. In some embodiments, the RO module is powered by a renewable energy source. In some embodiments, the system of the present disclosure includes a salinity adjustment module for identifying an optimal salinity for a feedstream to be sent to the RO module for desalination based on the available energy level of the system. In some embodiments, the salinity adjustment module combines feedwater streams from a variety of sources to create the feedstream for desalination at the RO module. In some embodiments, the system comprises a controller for controlling the various modules and flow streams, including operation parameters such conductivity, pressure, temperature, pH, backwashing frequency, chemical dosing rates, and the like. In some embodiments, the system includes an effluent stream of potable water.

In some embodiments, the RO system has adjustable flow configurations, allowing the system to switch between (by way of example) closed-circuit flow and 2-pass flow.

In some embodiments, the renewable power is any suitable renewable energy source. In some embodiments, the renewable energy source is photovoltaic. In some embodiments, the renewable energy source is hydroelectric. In some embodiments, the system includes at least one energy storage system.

In some embodiments, the present disclosure is directed to a method of adjusting feedwater salinity by utilizing two or more feedwater sources. In some embodiments, the adjustment is performed as needed and in real-time. In some embodiments, at least two of the feedwater sources have different salinity concentrations.

By adjusting the feedwater salinity level to match energy supply at that given time, the system achieves optimal power consumption. For example, when excess power is produced and must be curtailed (this incurs a cost), feedwater salinity would be intentionally raised, thereby utilizing the excess energy while producing water without adversely affecting reverse osmosis membranes (membranes have operational limitations relevant for avoiding significant membrane damage and/or excessive scaling/fouling); meanwhile, when available renewable power is very low, the feedwater salinity would be intentionally reduced to minimal levels to reduce the required energy for water production.

In some embodiments, the feedwater source is at least one of seawater, brackish water, or treated wastewater effluent. In some embodiments, a first feedstream is selected from seawater and brackish water, and a second feedstream is treated wastewater. Thus, in some embodiments, the present disclosure combines desalination and water reuse into one system. Such a system results in a higher utilization rate and is more reliable during and after extreme climatic periods, such as droughts. Seawater desalination plants alone can sometimes be unnecessary and less cost-effective once a drought passes. One example of this is in Australia, where seawater desalination capacity was rapidly increased because of a severe drought period; during heavy-rain periods, the desalination capacity was unnecessary and could not cost-effectively continue operation as intended. Further, having more than one feedwater source at different salinity concentrations (such as seawater and brackish water) can further enable brine dilution for release back to the sea. Multiple feedwater sources also ensure higher reliability and system utilization. Switching between different feedwater sources also helps reduce membrane fouling, which is known to inhibit overall system efficiency and increase cost.

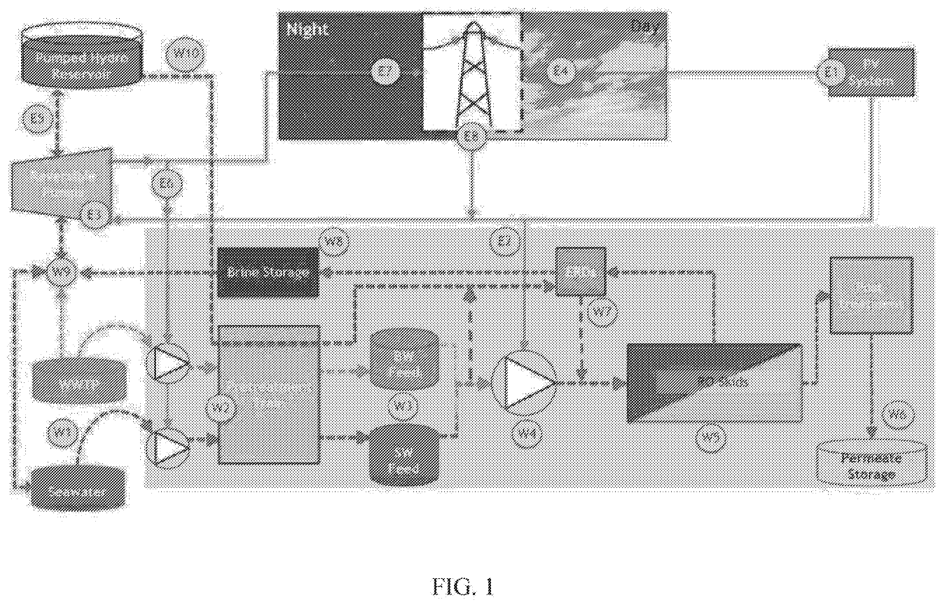

Referring to FIG. 1, in some embodiments, a feedwater stream from one or more feedwater sources flow passes through a pretreatment stage to remove potential membrane foulants (see W2). In some embodiments, pretreated water is then stored in feedwater tanks (see W3) for subsequent supply to a pumpset (see W4). In this figure, energy flow is shown with solid lines and liquid flow shown with dashed lines.

In some embodiments, during periods when it is operating in low-energy mode, feedwater streams having relatively low salinity is fed across the RO membranes. In some embodiments, the low-salinity feedwater stream is treated effluent. However, with the use of renewable energy both in the system and on the larger grid, excess electricity is generated. During periods when an increasing ramp rate in power occurs, the pumpset increases speed to match until reaching an upper limit of power consumption for desalinating low-salinity water.

In some embodiments, if excess electricity is still available after reaching this upper limit, feedwater streams from higher-salinity feedwater sources are blended into the low-salinity water to increase feedwater salinity. In some embodiments, the higher-salinity feedwater source is seawater. In some embodiments, flow rates and operation pressures are also increased to take advantage of the available excess power. In some embodiments, as long as there is an excess in energy, feedwater salinity would be increased in accordance with increased pump flow and pressure until reaching maximum pump power and feed salinity limits.

In some embodiments, once a decreasing ramp rate in power occurs, feedwater stream flow rates are adjusted accordingly to decrease salinity (higher-salinity feedwater streams are slowed or stopped) and reduce power consumption.

Referring again to FIG. 1, in some embodiments, product water from the RO modules (see W5) is stored for distribution (see W6). In some embodiments, product water flows through a post-treatment stage. In some embodiments, brine flow passes through energy recovery devices to recover pressure and transfer it back to the feedstream (see W7). In some embodiments, brine is subsequently retained (W8) and diluted (W9) before disposal. In some embodiments, a reservoir providing hydroelectric power is used as a feedwater source (see W10).

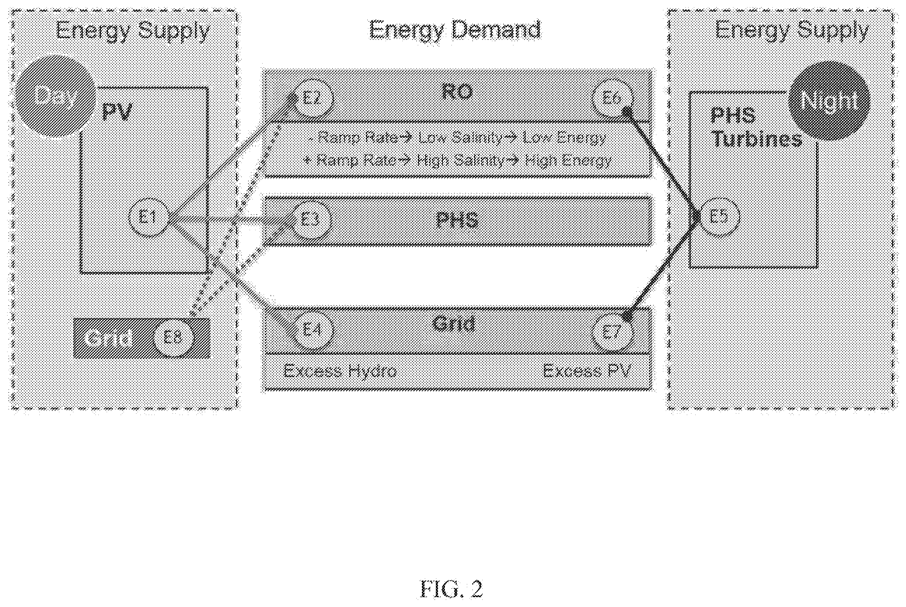

Referring to FIG. 2, in some embodiments, a renewable energy source (such as photovoltaic plant E1) is used to generate power for the RO system (E2). In some embodiments, the energy source also provides power to at least one pump (see E3) and surplus energy for the grid (see E4). In some embodiments, pumps E3 are pumped-hydro reversible pumps. During the day, the reversible pumps lift water to an high-elevation reservoir, and function as turbines at night or when solar irradiance is insufficient (see E5). When operating as turbines, they generate hydroelectric power for the RO system (see E6) and surplus energy for the grid (see E7). In some embodiments, grid power is stored by pumped-hydro energy storage. In some embodiments, grid power is used to supplement RO operations as needed depending on the water salinity level (see E8). Steps E1-E4 are in order of priority for daytime operations consistent with some embodiments of the present disclosure. On a typical day, PV powers the RO plant, followed by the pumped-hydro pumps, and any excess energy goes to the grid. During late afternoon, pumped-hydro pumps shift to turbine mode, continuing to power the RO plant and/or selling any excess energy to the grid. In parallel, the water flows to the RO plant night and day, but the volume of the wastewater treatment plants relative to seawater would increase or decrease according to the grid's needs and energy prices.

In some embodiments, the RO system is in a location having at least one of the following attributes: high renewable energy potential, favorable market conditions (policy, regulation, prices), proximity to a coast for seawater access, proximity to thermal power plants and wastewater treatment plants, proximity to brackish water sources, proximity to high-elevation terrain (approximately 200 m or greater) with natural depressions or existing reservoirs for pumped-hydro, away from restricted areas (such as protected areas, private ownership, and the like), and near electrical lines or substations.

Overall, the proposed innovation is a flexible, renewable-powered, variable-salinity RO plant that provides potable water and options of selling excess energy to the grid, providing grid energy storage, storing excess power generated on site, and enhancing energy consumption controllability through variable power and variable-salinity response. Utilizing a system that can tolerate two salinity-distinct feedwater sources achieves a wider electric load profile for operation. Furthermore, the concept offers the strong potential of retrofitting existing desalination plants and utilizing other existing energy or water infrastructure to reduce energy consumption, decrease capital and operating costs, and invoke flexibility to help dampen current and future stresses on the grid. Lastly, using treated wastewater effluent as a feedwater source provides an additional, consistent low-salinity input and promotes water sustainability through direct potable reuse.

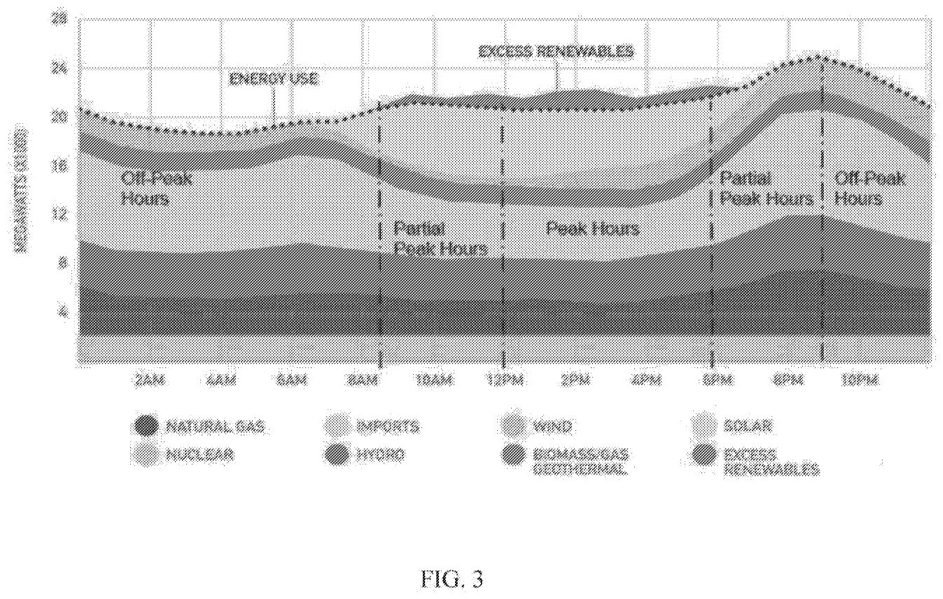

By way of example, California is an attractive location because of the high solar radiation (average annual global-horizontal-irradiation >5 kWh/m²/day), proximity to the sea, and abundant source of treated wastewater. Further, California has high-elevation coastal terrain for use with pumped-hydro energy storage. As shown in FIG. 3, California's load profile receives significant solar power penetration during the day, and storage can soften the grid's peak demand after sunset. Proximal thermal power plants with seawater intakes/outfalls can be used to reduce or eliminate RO seawater intake construction costs, and preheated water from once-through cooling systems can be exploited to increase membrane water permeability (i.e., produce more water). Nearby wastewater treatment plants can provide the minimum-salinity feedwater for the system; only a fraction of California's treated effluent is reused during the spring and summer mainly for irrigational purposes while the remaining flow is usually discharged to the ocean.

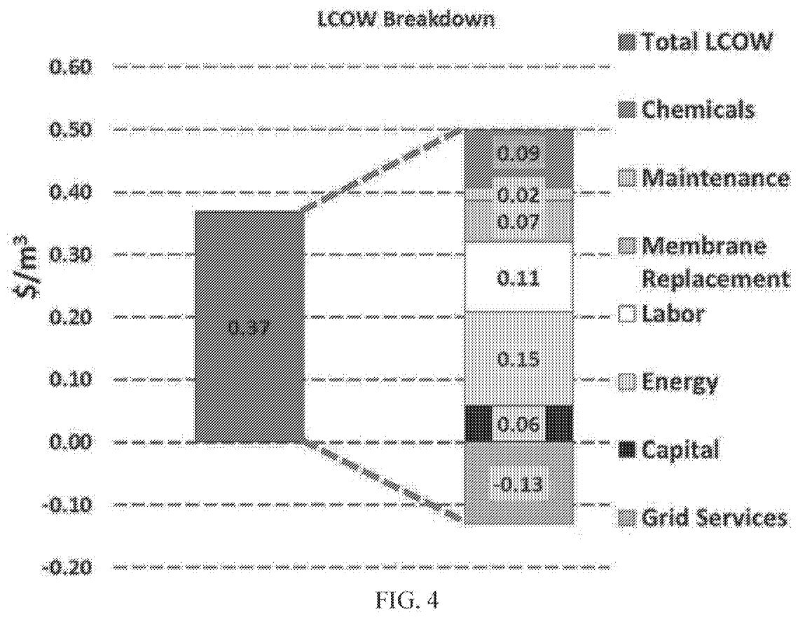

A techno-economic, hourly RO model developed by Columbia University, in combination with the HOMER energy model, was used to make initial estimates of the efficacy of the systems and methods of the present disclosure using California as the target. The systems and methods were found to produce 16,000 m³/day at 350 ppm TDS, with a 95% productivity factor. The system desalinated 5,000 ppm treated effluent at an 80% recovery rate for 75% of the time and 37,000 ppm seawater at a 50% rate for 25% of the time. The electric load varied between 0.4-1.2 MW. The on-site power system comprised 5 MW, one-axis tracking PV and 1.8 MW pumped-hydro energy storage connected to the grid. The estimated levelized cost of water was 37 cents/m³ (see FIG. 4). Energy accounted for approximately 35% of the overall water cost, but this is offset by services to the grid which reduce energy costs from about 15 cents/m³ to about 2 cents/m³.

The capital cost of 6 cents/m³ is based on an RO system base cost of $3,000/(m³/day) and additional financial factors. Total electricity sold to the grid was 8.8 GWh/year, yielding a 13 cent/m³ reduction allocated to grid services. Labor costs account for 11 cents/m³. The membrane replacement cost of 7 cents/m³ is based on an annual membrane replacement rate of 12.5%. Maintenance costs for spare parts are assumed to be 2 cents/m³. Chemical costs account for pretreatment and post-treatment. Monthly San Diego feedwater temperatures were assumed to undergo a 10° C. increase to simulate feedwater preheated by a thermal power plant. PV and pump-hydro system capital costs were set to $1,600/kW and $1,000/kW, respectively; annual operational and maintenance costs were assumed as 2% and 9% of capital costs, respectively. Industrial, scheduled tariff rates were used for the grid model, and sellback price was set equal to purchase price.

Non-limiting exemplary applications of some embodiments of the present disclosure include reverse osmosis desalination and water reuse systems for freshwater production; energy and water production systems, such as deployable systems for emergency and disaster responses that impact an area's drinkable water; and retrofitting conventional desalination plants to enable operational flexibility and reduced energy consumption.

Although the invention has been described and illustrated with respect to exemplary embodiments thereof, it should be understood by those skilled in the art that the foregoing and various other changes, omissions and additions may be made therein and thereto, without parting from the spirit and scope of the present invention.

What is claimed is:

1. A system for desalinating feedwater, including:
at least one feedwater source;
a reverse osmosis module;
at least one input feedwater stream fed to the reverse osmosis module, wherein the input feedwater stream comprises water from at least one feedwater source, wherein said at least one input feedwater stream comprises a first feedwater stream and a second feedwater stream, wherein the second feedwater stream has a salinity higher than a salinity of the first feedwater stream; and
a controller analyzing the level of energy available to the system, wherein the controller increases the salinity of the input feedwater stream proportional to an increase in available energy by increasing the proportion of the second feedwater stream in the at least one input feedwater stream.

2. The system according to claim 1, further including at least one power source selected from the group consisting of: a renewable energy source and an energy grid.

3. The system according to claim 2, wherein the renewable energy source is at least one of a photovoltaic energy source and a hydroelectric energy source.

4. The system according to claim 1, wherein the controller decreases the salinity of the input feedwater stream proportional to a decrease in available energy.

5. The system according to claim 1, further including an energy storage system.

6. The system according to claim 1, wherein said at least one feedwater stream comprises a first feedwater stream of wastewater effluent and a second feedwater stream of seawater.
